(19) United States
(12) Patent Application Publication
(10) Pub. No.: US 2004/0128399 A1
(43) Pub. Date: Jul. 1, 2004

(54) Media stream control system and protocol

(75) Inventor: Peter G. Kurrasch, Palatine, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/334,593

(22) Filed: Dec. 31, 2002

(51) Int. Cl. G06F 15/16

(52) U.S. Cl. 709/250; 709/245; 709/203; 709/231

(57) ABSTRACT

A control system protocol for identifying media streams and a simplified syntax for implementing control of the identified media streams. The protocol involves the control of media streams remotely as well as at the local machine and provides for common commands to be specified by a user, creates provisions to allow for flexibility for use of commands, and insures that the URI can be used in HTML documents so that control of the present invention can be exercised within graphical displays displayed in a browser employing web pages and the like. A control protocol relay is provided to implement various functions and processes to employ the control protocol across various networks and devices.

### FIELD OF THE INVENTION

The present invention relates generally to streaming media control systems and, more particularly, to a command protocol for controlling data streams originating from a variety of devices.

### BACKGROUND OF THE INVENTION

Convergence, as relates to technology, has typically referred to the combination of television and online computing. However, as access to the Internet, particularly through broadband high-speed connections, becomes increasingly ubiquitous, ever increasing amounts of data from many different devices is being carried on these high-speed connections. As such, convergence is quickly being understood to encompass the intersection of broadcasting, computers, telephones, video and more.

The content of multimedia data streams from all of the above devices has a wide variety of technical issues that are specific to each different type of multimedia stream and even specific to each different device originating a given type of multimedia stream. Accordingly, the new protocols such as, SIP, for example, require greater specialization and, therefore, are directed to the handling of very specific media presentations. Although technology may be improving the presentations of the differing media, a common platform for the access and control of the media has not been satisfactorily developed.

### BRIEF DESCRIPTION OF THE DRAWINGS

FIG. 1 is a flow diagram illustrating an exemplary URI message in operation in accordance with an embodiment of the inventions;

FIG. 2 is a block diagram of an exemplary system utilizing the media stream control system in accordance with an embodiment of the invention;

FIG. 3 is a block diagram of an exemplary implementation of the system of FIG. 2 in accordance with an embodiment of the invention;

FIG. 4 is a block diagram of an exemplary network deployment of the media stream control system in accordance with an embodiment of the invention; and

FIG. 5 is a flow diagram of the media stream control system in operation in accordance with an embodiment of the invention.

### DETAILED DESCRIPTION

The Internet has brought about media convergence where a user is able to access various streaming media sources to listen to radio broadcast, view movies, and experience other streaming multimedia content, all over the same communications network. The control system of the present invention relies upon a protocol for identifying media streams and a simplified syntax for implementing control of the identified media streams. Since the protocol of the current invention involves the control of media streams remotely as well as at the local machine, the term “tele-media” is used to reference the control protocol (“TMCP”) of the present invention.

The TMCP, among other functions, primarily provides control of remote devices to manage streaming data facilitating a general-purpose protocol and control mechanism that allows for the remote operation of a diverse array of devices. Such devices include home automation equipment as well as audio and video equipment, including, for example, telephones and cable television. TMCP also has applications as a generic proxy service.

The technical aspects of control of a media stream manifest significant differences from one media stream to another for two basic reasons. First, not all streams can be manipulated in the same way. For example, streaming radio broadcast cannot generally be stopped and restarted from where it has been stopped. Second, the ways in which the streams are presented to the user are remarkably different. For example, a CD player cannot generally play back an audio track from videotape. These differences relate to the fundamental technologies underlying these media streams. An end user may wish to control playback of an audio track whether from video tape or from a CD player with a common volume control, such as, for example, if the audio is playing too loudly and needs to be turned down.

With an increasing focus of technology on mobile devices and distributed applications, the present invention provides simplified protocols and compact control modules that are adapted for use in devices that have minimal intelligence but are able to exploit the full range of streaming media capabilities and technologies. Advantageously, the present invention provides a protocol and control system that recognizes the similarities within the control of media streams and takes advantage of those similarities to present a simplified protocol usable by a variety of different platforms in accessing and controlling different media streams.

Further, a generic, simplified front end is provided where users can input intuitive commands to control streaming media applications. Advantageously, although systems and protocols are generated via different devices and technologies, the users need not have knowledge of specific hardware controls or capabilities in order to operate devices for media stream applications. This intuitive command interface or front end recognizes the command input and translates them into actions that facilitate the end users accessing and controlling appropriate media streams.

The control system of the present invention relies on the identification of the type and nature of the media stream as well as the type of stream requested by the end user. This media stream identification information is translated into control sequences that may be relayed into other hardware running this control system software or translated on the spot into instructions for either the hardware or other applications to initiate various actions involving the generation and control of media streams. In the TMCP protocol, a media stream source or open media stream is identified for purposes of issuing the appropriate control of the media stream. The scheme is known as a uniform resource identifier scheme (hereinafter URI scheme) which is consistent with the conventions set forth in the RFC 2396: T. Bemers-Lee, R. Fielding, L. Masinter, “Uniform Resource Identifiers (URI): Generic Syntax”, August 1998.

Accordingly, a Uniform Resource Identifier (“URI”) scheme of the presently described system and protocol provides for common commands to be specified by a user. In addition, the URI scheme creates provisions to allow for flexibility for use of commands and insures that the URI can be used in HTML documents so that control of the present invention can be exercised within graphical displays displayed in a browser employing web pages and the like. A TMCP relay is provided to implement various functions and processes to employ TMCP across various networks and devices.

The top-level structure of the URI protocol syntax consists of the scheme name and the scheme data, as shown in the following two statements ((1) and (2)):

(1) tmcp_uri=“tmcp:” scheme_data *(“;” scheme_data); and

(2) scheme_data=(connection_oriented|connectionless)

Specifying “tmcp:” designates the command as media stream control command, i.e., indicates that the remaining text in the URI adheres to the TMCP specification as identified in herein. The scheme data for a TMCP URI consists of a connection-oriented part or a connectionless part.

The TMCP URI format enables multiple actions to be listed sequentially in a single URI statement. By combining the statements into one URI, one TMCP message may contain multiple actions instead of requiring multiple messages with only one action per message. In a particular embodiment, where multiple scheme data portions are included in a single URI statement, the URI is processed in the order it appears from left to right with the first portion processed first, the second portion processed second, and so on.

The terms “connection-oriented” and “connectionless” are telephony terms used to indicate if a given message is or is not associated with a particular connection. For example, sending a message to terminate a phone call is a connection-oriented message because one must identify which connection (i.e., phone call) is to be terminated. In contrast, sending a message to initiate a phone call is an example of a connectionless message because no connection (i.e., phone call) has been established.

For the media stream control protocol both connection oriented and connectionless messaging are alternatively supported in the URI protocol syntax (see statement (1)). As shown in the following protocol syntax statements the addition of “reference_number” differentiates a connection oriented and connectionless URI statement (see statements (3) and (4)):

(3) connection_oriented=reference_number “,” connectionless

(4) connectionless=action[“,” operands]

(5) reference_number=1*alphanum [“−“*(0..9) *(0..9)]

The term “reference_number” includes one or more alpha numeric characters, “alphanum”, and is case insensitive. The purpose of the term “reference_number” is to establish an identifier that is unique for a particular TMCP session. Thus, a system capable of having multiple, distinct sessions simultaneously active will be able to use this reference number to effectively distinguish between the sessions. Thus, one may choose to identify a specific stream within the session or the session as a whole. For example, “mysession” implies the entire session, whereas “mysession-001” implies only the stream numbered “001” within the session.

The action field in the URI media stream protocol of the present invention consists of a word describing what media stream control the sender would like the receiver to perform. The applicability of specific actions depends upon the receiver of the media control protocol message. For some actions such as initialization of a media stream, i.e., “init” action, the reference number is not needed and is assigned when the media stream session is established. If multiple actions are included in a single URI, any action that does not specify a reference number is understood to use the reference number as the action immediately proceeding it. Additionally, if a stream number is not identified as part of a reference number, the given action is to apply for all streams in the media stream session or media stream connection.

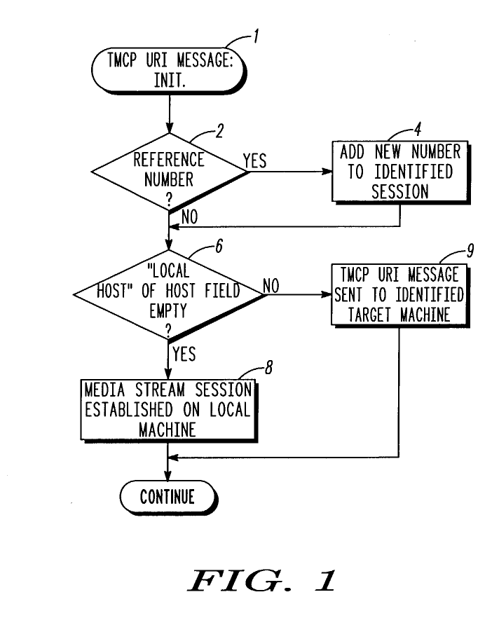

Referring now to specific actions and their steps, reference is now made to FIG. 1, which is a flow chart illustrating the steps to perform the “init” action. If in step 2 the TMCP URI message includes a reference number then the assumption is that a media stream will be added to the identified session. This is done by adding a new number to the identified session. For the “init” action the operand field of the TMCP message is parsed in step 6 by determining the parameters of the host field. If the host field is empty or “local host” is specified, then the media stream is established in step 8 on the local machine according to the remaining operands. Otherwise, in step 9, a TMCP URI message is sent to the identified host or target machine, which will perform the initialization of the requested media stream. It is to be noted that the illustration of the operation of the “init” action is by way of example only. Other actions, as described below, although not illustrated operate in a somewhat similar manner.

An example of an action that may be included within the protocol of the presently preferred embodiment includes, but is not limited to “fini” to terminate a media stream session. For this action, a reference number should be included to identify exactly the session to be terminated. Considerable other actions are employed, as discussed below. For example, the “start” action is used to begin the playback of a stream within a media stream session. The operations performed to carry out the “start” action are dependent upon the stream data. The system providing the media stream subject to a “start” action determines if a start action is appropriate for a given stream.

The “stop” action is used to stop playback of a stream within a tele-media session. The exact meaning of a stream in the stopped state is dependent upon the stream data itself. The tele-media server providing the stream determines if a stop action is appropriate for a given stream

The “pause” action is used to temporarily interrupt the playback of the specified stream. The exact meaning of a stream in the “paused” state is dependent upon the stream data itself. For example, when playing a track on an audio CD, a pause interrupts the playback at that specific moment in the track so that a resume may continue playback accordingly. In contrast, a stop not only interrupts the playback but also stops the spinning of the CD.

The action “blank” is used to temporarily prevent the sending of the specified stream data to the tele-media user. A blank is perhaps best thought of as a mute or silence operation. Neither term is used in TMCP, however, because both refer to a stream that contains audio data and neither is directly applicable to a non-audio stream. The term blank is therefore chosen to mean “don't send me data (or if you must send me data, make it blank data).” Such distinctions between blank, stop, and pause are not required and are to be determined by the tele-media provider based on the stream data in question.

The “resume” action is used to restore the sending of stream data to the tele-media user. Such a restoral is likely to occur after a pause or blank action has been performed.

The action “up” is a generic action used to indicate that the particular stream should “go up or increase”. For example, if a tele-media session uses a video camera, an up action could instruct the camera to pan upwards. Another potential use for up is to control the volume of an audio stream, in which case the user would like the volume increased.

The action “down” is a generic action used to indicate that the particular stream should “go down” or “decrease”. For example, if a tele-media session uses a video camera, a down action could instruct the camera to pan downwards. Another potential use for down is to control the volume of an audio stream, in which case the user would like the volume decreased.

For the above-described actions, the operands field is not required. However, if used, its interpretation is at the discretion of the URI recipient.

The action “forward” is a generic action used to indicate that a stream should “go forward” from its current position. For example, a video player could respond to a forward action by either moving forward within the stream or by playing in a forward direction.

With respect to the operands, although their use is not required, one possible use is to distinguish between a “play in the forward direction” and a “skip ahead in a forward direction” command. For example, one could dictate that “tmcp:forward” means only “play forward” while “tmcp:forward,/by/5s” means “skip ahead in increments of 5 seconds”. As another example, a URI of “tmcp:forward,/by/2m;pause” could mean “skip ahead by 2 minutes and then pause playback”. Note that in these examples the reference number is not shown but may need to be included in the URI as sent to the tele-media server.

The action “reverse” is a generic action used to indicate that a stream should “go backward” from its current position. For example, a video player could respond to a reverse action by either moving backward within the streams or by playing in a reverse direction. Although use of the operands is optional, one possible use is to distinguish between a “play in the reverse direction” and a “go backward” command. For example, one could dictate that “tmcp:reverse” means only “play backward” while “tmcp:reverse,/by/5s” means “skip backwards in increments of five seconds”. As another example, a URI of “tmcp:reverse,/by/2m;pause” could mean “go backwards by 2 minutes and then pause playback”. In the present examples, the reference numbers are not shown but may need to be included in the URI as sent to the tele-media server.

The action “previous” is a generic action used to indicate that a stream should go backward from its current position to a previous marker in the stream. For example, a CD player could respond to a previous action by going back to the previous track. Or, a video player could respond by going to a previously marked scene. In this case, operands may optionally be used to indicate the particular marker to which to go. For example, a URI of “tmcp:previous,/by/3” could mean “go” to the third previous marker in this stream”. Note that although the reference number is not shown in this example, it may be necessary when sent to the tele-media server.

The action “next” is a generic action used to indicate that a stream should go forward from its current position to the next marker in the stream. For example, a CD player could respond to a next action by going forward to the next track. Or, a video player could respond by going to the next marked scene. Operands, although not required, may be used to indicate the particular marker to which to go. For example, a URI of “tmcp:next,/by/3” could mean “go to the third-next marker in this stream”. Again, although the reference number is not shown in this example, it may be necessary when sent to the tele-media server.

The “goto” action is a generic action designed to be a catch-all for many TMCP behaviors. For example, its use could indicate that an init request should be redirected to another location. Or, goto could indicate that one end of the tele-media session is changing its IP address (as may be the case when a call leg is directed to another extension). Alternatively, the goto action directs the server providing a tele-media stream to go to a specific point in the stream, such as “go to track 7, 5 minutes, 10 seconds on the audio CD”. The exact significance of goto depends on when it is being used as well as the stream being operated upon and any operands supplied. The goto action is not likely to have a particular state associated with it, although one certainly may be provided as its use is deemed necessary. For example, a tele-media server may want a state to indicate “I received your request, I replied with a goto to redirect you to another server, and I am waiting for this session to end”. With respect to the operands, their use is required, though the exact structure and format to use will depend on a given stream. For example, a redirect may look something like “tmcp:goto,/otherhost.com/othercategory/othername”. For the audio CD case mentioned above, the URI with operands looks something like “tmcp:goto,/track/07/5m10s”.

It is to be understood that the available actions are not limited to those discussed herein. Rather, other actions may be defined and used as needed to control streams. Furthermore, it is also to be understood that certain operands may be more appropriate and/or convenient for a given device, application or whatever else is being controlled by the TMCP URI. As such, in certain cases particular operands may be required to be provided in order for a given action to make sense and operate as intended and appropriate. Advantageously, the system's flexibility enables the system designer to specify these necessary or desired operands.

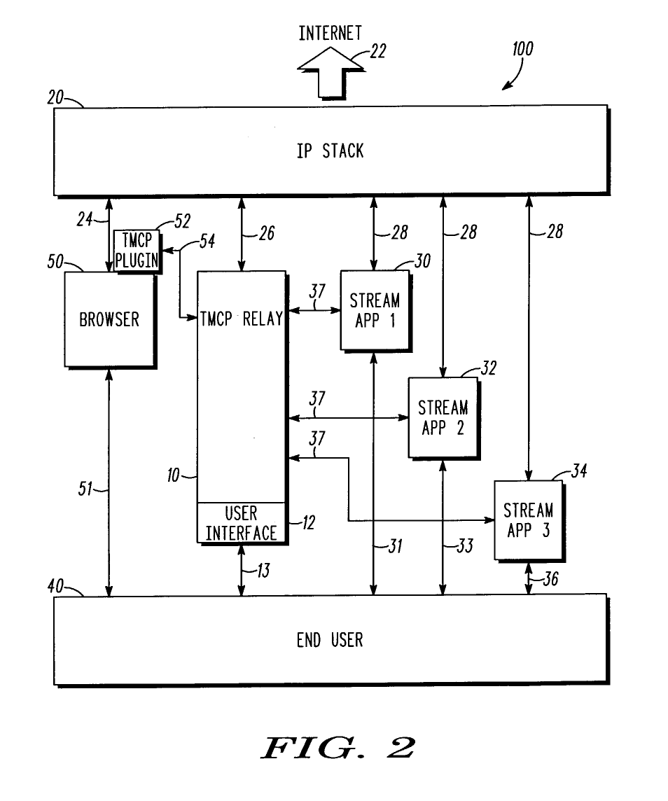

FIG. 2 shows a block diagram of an exemplary media stream control system 100 in accordance with an embodiment of the present invention. Although the Internet, as shown, is the most likely network in which TMCP may be used, it is intended to be compatible with any networking technology and is not limited to the Internet. In particular, the network may be a telecommunication network, such as a cellular telephone system or other wireless technology. As mentioned above, the devices that implement TMCP may not only be of minimal intelligence, but also may be wireless, mobile devices. Such devices may optimally use the TCP/IP 20 stack and/or the Internet, but are not required to do so.

In the illustrated embodiment, the media stream control system 100 includes a browser 50 having a TMCP plugin 52, a TMCP relay 10 includes a user interface 12, and several exemplary streaming applications 30, 32, 34. The interfaces 31, 33, and 36 between the streaming applications 30, 32, 34 and an end user 40 are provided for presenting the multimedia/data stream to the end user 40. The interfaces 24, 26, 28 connect the browser 50, TMCP relay 10 and the streaming applications 30, 32, 34 to an IP stack 20. The interface 26 between the IP stack 20 and the TMCP relay 10 represents the exchange of protocol data between the device in question for FIG. 2 and some remote device.

The IP Stack 20 represents a possible network-access technology and/or protocol. To use the cellular network example, the network access stack could actually be the standards/protocols/mechanisms of the particular cellular technology (i.e., access to a CDMA network is totally different than to a GPRS network).

A network interface 22 is provided to connect the system via the IP stack 20 to an external network, such as the Internet. The network interface 22 includes not only Ethernet or a dial-up modem, but may also include cable modems, DSL, ATM, an air interface or the like, defined by a cellular standard (e.g. CDMA, TDMA, GSM, GPRS, UMTS).

An interface 51 enables the end user 40 to communicate with the browser 50 to enable browser data to be presented to the end user 40. For example, the interface 51 may comprise a collection of Windows and GUI controls rendered via some video screen. Keyboard and mouse interaction is available as well. Advantageously, the present system does not require the presence of the browser 50 for proper operation.

The end user 40 communicates with the user interface 12 of the TMCP relay 10 through an interface 13, to present the end user 40 with TMCP controls. This may be, for example, a “setup” or “control panel” program. Thus, the interface 13 serves as a means to configure TMCP itself. In addition, the relay 10, the user interface 12 and the interface 13 provide the user with the necessary control and status information and how to control them if the browser 50 is not present or is unable to execute its functions.

The interface 24 between the browser 50 and the IP stack 20 represents the exchange of data used to provide the end user 40 control over the TMCP session (i.e., sessions includes the manipulation of data/multimedia streams). Typically the data on the interface 24 is a mark-up language, such as HTML (HyperText Markup Language), XML (eXtensible Markup Language), WML (WAP Markup Language), JavaScript, or other scripting language. The protocol used on the interface 24 may be HTTP (HyperText Transfer Protocol), WAP (Wireless Application Protocol), Bluetooth, or the like. One consideration is that the data exchanged may include the TMCP URI. For example, if the user is loading a web page, the HTML text could contain a hotlink reference that is constructed using the TMCP URI format.

The interfaces 28 between the stream applications 30, 32, 34 are used for streaming, for example, audio encoded in a convenient format. Such formats include MP3, PCM and others. Streaming media applications other than audio are also possible. Most streaming media applications share similar control characteristics independent of the type of device or application originating an audio media stream such as a compact disc player, audio stream, or voice messaging application. Accordingly, there exist certain common control features exercised by the user. For all three of the interfaces 28 (and their corresponding stream applications), the number of streams/stream applications is not important and, moreover, the stream applications may or may not be related to each other (e.g., an audio stream and a video stream may both be part of a single broadcast, such as video conference, or they could be completely unrelated if, say, the audio was some radio broadcast and the video was from a security camera). Thus, the data content and protocol used is completely independent of TMCP and is specific to whatever stream application is employed.

The stream applications discussed further below need not interact with the network in order to be useful. Instead, the stream application could interact with an entity local to the device, such as a CD player. For example, when using an application which generates audio streaming data a user will expect to be able to turn up the volume or turn down the volume, mute the audio playback, or, depending upon the source of the stream, change position within the stream. However, different devices or applications may require very different technology considerations regarding their playback either by the source or at the end users terminal.

Advantageously, the interface 26 is where the TMCP relay 10 protocol data is exchanged between the device in question for FIG. 2 and some remote device. The TMCP relay 10 simplifies the control of stream applications 30, 32, 34 by use of the URI command set, which exploits the common control features of media stream applications as described above. It will be appreciated that the TMCP relay 10 further provides other services that permit an interactive, multimedia session to occur in the first place. Such services include: user authentication/authorization, resolution of the ultimate destination (i.e., resolve the URI notation to a proper destination), firewall/proxy traversal, and to some extent the negotiation between the local and remote entity as to the proper encoding format(s) for the data streams.

TMCP relay 10 is installed into an end user system, which may require some configuration through a direct user interface 12 within TMCP relay software. The end user 40 then uses a standard set of commands defined for TMCP relay 10 and a standard protocol and syntax communicated by plug-in 52 and interpreted by TMCP relay 10.

The TMCP relay 10, which maybe a hardware device or software interface, simplifies the control of stream applications 30, 32, 34 through an interface 37 by use of a command set which exploits the common control features of media stream applications. Note that the interface 37 also may be a device-specific activity. In that case, the TMCP relay 10 performs a general-purpose to device-specific task. For example, if a stream application is considered to be some type of combination of hardware and/or software, then the stream application 30 may be manipulated via a software API or device driver, etc., yet stream application 32 may be manipulated through direct hardware control.

Advantageously, the TMCP relay 10 provides other services that permit an interactive, multimedia session to occur in the first place. Such services include: user authentication/authorization, resolution of the ultimate destination (i.e., resolve the URI notation to a proper destination), firewall/proxy traversal, and to some extent the negotiation between the local and remote entity as to the proper encoding format(s) for the data streams The TMCP relay 10 is not bound to a particular technology. Although the Internet is the most likely network in which the TMCP relay 10 may be used, it is intended to be used in any networking technology and is not limited to the Internet. In particular, the network may be a telecommunication network, such as a cellular telephone system or other wireless technology. As mentioned above, the devices that may implement TMCP may not only be of minimal intelligence, but also may be wireless, mobile devices. Such devices may optimally use the TCP/IP stack and/or the Internet.

The exchange of relevant TMCP data between the browser plugin 52 and the TMCP relay 10 is done through an interface 54. This enables TMCP URI-type messages to be sent to the TMCP relay 10. The TMCP relay 10 operates within a typical computer system at the application interface layer coupled to the top level of the IP stack 20. The IP Stack 20 represents a possible network-access technology and/or protocol. To use the cellular network example mentioned above, the network access stack could actually be the standards/protocols/mechanisms of the particular cellular technology (i.e., access to a CDMA network is totally different than to a GPRS network).

The TMCP relay 10 simplifies the playback and transmission control functions, since a user command format is implemented wherein the end user 40 can select generic or intuitive commands as displayed graphically or otherwise in HTML format by the browser 50. The TMCP relay 10 interprets the commands from the plug-in 52 by parsing and using the parsed commands to determine: 1) whether a media stream application should be invoked on the local machine; 2) whether a message should be sent to a remote machine hosting a TMCP relay 10; and 3) whether a TMCP identifier has to be sent to a TMCP name server to resolve an address location. Preferably, the end user 40 interacts transparently and seamlessly with the media streams through the TMCP relay 10. This transparency is achieved in part through the browser plug-in 52 which facilitates communication of commands by display in a browser window and by links in the displayed browser windows which when selected sends messages to TMCP relay 10 which are then used to formulate TMCP messages which are sent to remote machines or initiate actions on the local machine of end user 40.

Advantageously, the TMCP relay 10 also facilitates interoperability including platform and device independence. The multimedia data stream then interacts with Stream Application 2 32. For example, the stream is used for streaming video that is encoded in some convenient format, such as MPEG. Likewise, the multimedia data stream that interacts with Stream Appliation 3 34 is, for example, to be used for some type of Internet chat sessions. Other possibilities could include streaming audio, email, stock market quotes, etc., which, for example, may be handled by Stream Application 1 30. Thus, the user does not have to have knowledge of the specific hardware controls or capabilities to initiate or control each device necessary for a media stream application.

The interface 36 enables a presentation of the multimedia/data stream information to the end user 40, e.g., for Internet chat sessions. The interface 36 may involve the pertinent windows, keyboard, video display, and other devices necessary to engage the end user 40 in a chat session. Using the syntax of the protocol for TMCP relay 10, the user initiates the media stream without knowing the exact composition of the data or control structure required by the software or hardware being utilized for playback.

According to an embodiment of the invention, the protocol and syntax defines the commands communicated to TMCP relay 10 either from end user 40 directly, or via a browser 50 as used herein, as any appropriate user interface to the devices through plug-in 52 or from other components of the TMCP control system through the Internet via the IP stack 20. An interface 54 is an exchange of relevant TMCP data between the browser plug-in 52 and the TMCP relay 10. On the interface 54, the plug-in sends TMCP URI-type messages to the relay and the relay sends a combination of TMCP messages and mark-up text. As an example, where the browser directs the user to click on a link at which point the plug-in sends the TMCP message to the TMCP relay 10, the TMCP relay then initiates a session with the appropriate stream application and then indicates back to the plug-in that the action was successful.

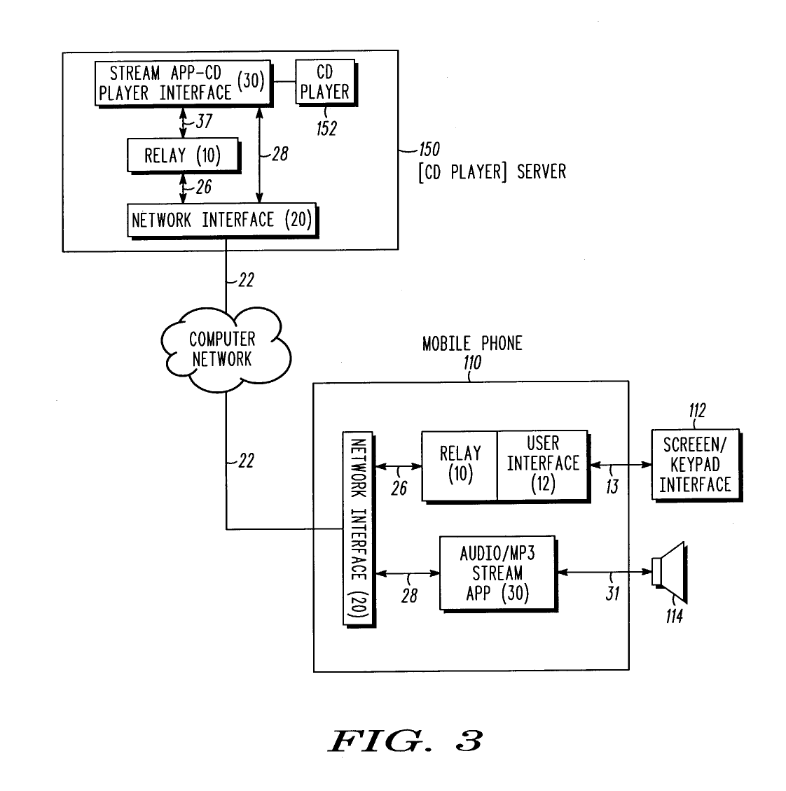

FIG. 3 provides a specific exemplary application illustrating the components that may be represented in FIG. 1 in which, for example, a mobile phone 110 is being used to listen to an audio CD in a CD player 152 that is part of a computer server 150. The user uses a screen/keypad interface 112 on the phone to indicate the track desired for listening to the sound coming out of the speaker 114. Internally, the phone 110 and the server 150 have many of the components and interfaces previously identified in FIG. 2.

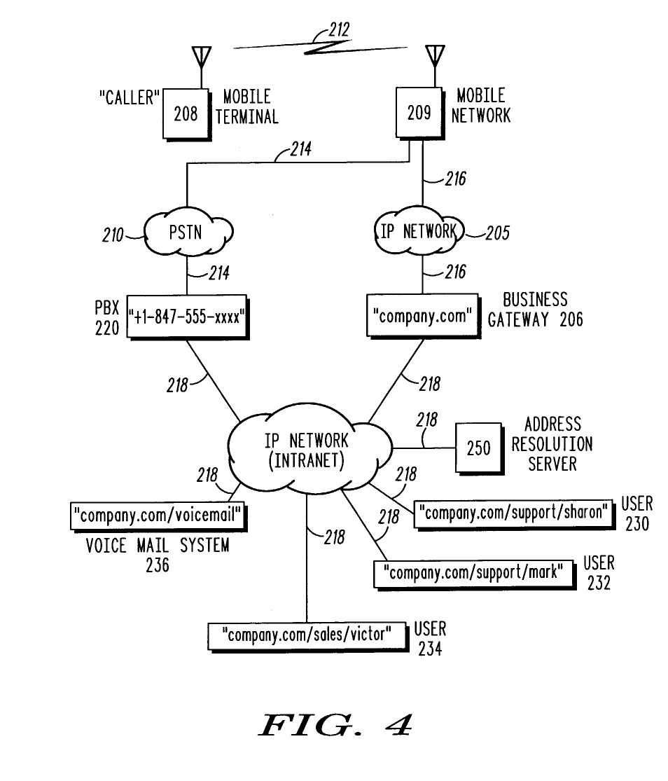

Within the network deployment of the media stream control system of FIG. 4, each of the devices having a relay module 10, communicates with any other device having a relay module utilizing TMCP. As discussed above, relay module 10 communicates utilizing IP across the Internet 205 or any other IP capable network such as the intranet 204. Gateway services are employed in communicating with devices or networks such as a business gateway 206 to the intranet 204, or Internet gateway to devices serving within a mobile or wireless system network.

The user on a mobile terminal 208 accesses all the previously referenced devices and networks via the relay modules 10 both in the devices themselves and in the various gateways, e.g., 206, utilizing the mobile terminal 208 with a relay module 10 which operates in a wireless mobile mode. The mobile terminal 208 could include a cellular phone, a personal computer using a wireless LAN (such as IEEE 802.11b), a personal computer connected to a cellular phone, a Bluetooth capable device, or other such entities. It will be appreciated that the wireless interface (not shown) may use radio-frequency spectrum or other means of transmission such as lasers, infrared, and the like. A mobile network 209 may be necessary to include one or more wireless transceivers combined with internal routing equipment.

A caller using the mobile terminal 208 accesses a wireless interface 212 such as a cellular telephone network. The mobile network 209 accesses the Public Switched Telephone Network (PSTN) 210 using standard telephone interfaces 214 between the mobile network and a PBX. The actual interface could be ATM, E1/T1, or any other appropriate interface. A PBX box 220 is installed at a company site and having, for example the 576 prefix assigned for use by the company. That is, if 1-847-576-5000 is called, the call will be routed to that box.

An IP-based network 205 uses an appropriate interface 216 which may include ATM or frame relay or Ethernet. An internet gateway 206 provides a firewall between the external internet 205 and the company's own intranet 204. This gateway has some address to which the company.com domain name is assigned. An intranet 204 is local at the particular company and uses the interface 218 to communicate between the various nodes on the network. The interface 218 may be Ethernet or the like. An address resolution server 250 is provided for resolving TMCP addresses to a particular location. The server 250 is not a Domain Name Server (DNS), although such functionality may be incorporated therein. For example, three users are shown on the network, “Sharon” 230, “Mark” 232, and “Victor” 234, e.g., Sharon and Mark may be part of a support team while Victor is part of a sales team. The users may also have access to a voice mail system 236.

By way of example, a user, via some mobile terminal 208, clicks on a link within a micro browser. The URI associated with that link is “tmcp:mysession,init,//company.com/support/sharon”. The mobile terminal then communicates the TMCP request (using whatever format is convenient) over the air interface 212 to the mobile network 209. Included in the request are some capabilities of the mobile terminal, including such things as supported audio encoding schemes. The mobile network then sends the TMCP request to the business gateway 206 via links 216 and the IP network 202. The business gateway 206 recognizes the TMCP request and forwards the request to an address resolution server 250 via the company intranet 204. The address resolution server takes in the TMCP request and, via some internal database of its own, notices that Sharon has forwarded her calls to Mark. This server then changes the request to be “tmcp:mysession,init,//company.com/support/mark” and sends the request on to Mark 232. Although the address resolution server changed the request, the equipment Mark is using still knows who sent the original request (e.g., this can be done via the IP sources address or other means which are beyond the scope of TMCP). Alternatively, the server does not change the URI request itself, but instead ensures that the request gets directed to Mark 232, regardless of the particular syntax of the TMCP request. For example, Mark 232 may still choose to answer the call, but would at least be aware that the call originally was intended for Sharon 230.

The machine selects a suitable audio encoding scheme and replies back to the caller, via a suitable TMCP URI, to reflect that the establishment request was received and to indicate how the media session might progress (i.e., what stream applications are necessary for the audio exchange). At this point, the equipment Mark is using may alert him, via a browser for example, to the incoming call and offer him a choice of links to either start talking (“tmcp:mysession,start”) or ignore the call (“tmcp:mysession,fini”) or forward the call to voice mail (“tmcp:mysession,goto,//company.com/voicemail/”). Upon selecting a link, a TMCP request is sent via the intranet, the business gateway, the IP network, and the mobile network to the caller. Assuming Mark accepts the call, he and the caller proceed to talk. When the conversation is over, one and/or the other select a link to end the call. The URI associated with that link is “tmcp:mysession,fini”.

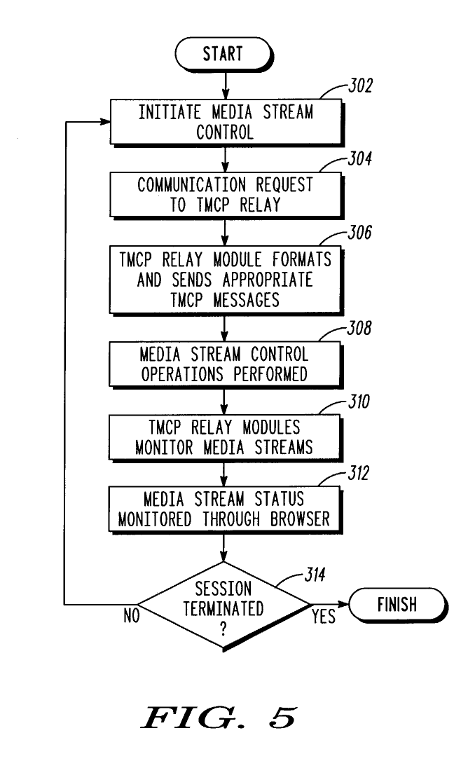

In accordance with an embodiment of the present invention, a method for controlling a media stream generated on interconnected computers by a media stream application which controls the playback or generation of media stream data is illustrated in the flow chart of FIG. 5 and described below with reference to operational flow 300. Preferably, an end user in step 302 selects a link within the browser that initiates control of a media stream. In step 304, the browser, via plug-in 52, sends a communication request (TMCP URI) to the TMCP relay process 10 located within the end user's system

The TMCP relay 10 formats and sends the appropriate TMCP messages. This is done when the TMCP relay 10 combines the URI statement with known capabilities of the indicated device or media stream and formats the corresponding required TMCP message or messages and then sends the TMCP message(s) out onto the network in step 306 by sending the message through the IP stack 20 to the destination device and awaiting a response. In step 308, the media stream control operations get executed on the target devices. It will be appreciated that the target in steps 306/308 are not always on a remote system. That is, the target of a particular operation could very well be a stream application on the local machine. The response from the destination device indicates the exact capabilities of the stream to be created.

For example, when initiating a session or adding streams to an existing session, upon reception, the TMCP relay 10 in step 310 is able to spawn the appropriate stream application 30, 32, or 34 to receive the stream data for monitoring purposes. The end user 40 is then notified in step 312, via a web page displayed in the browser 50, which is used to monitor the media stream, that the session has been established. The browser's 50 graphical display indicates the controls available during the session, including a link that the user may click on to terminate the session. The process repeats until it is determined in step 314 that the session is terminated.

It is to be noted that in addition to the above discussed TMCP parameters, such as the types of audio formats that the device is able to understand, other “raw data” may be included in the TMCP message. That is to say that a proper TMCP message will consist of: 1) the URI describing what actions are desired for a given stream; 2) optionally, a set of parameters or capabilities that govern how a device will participate or is able to participate in a tele-media session; and 3) optionally, raw data that is pertinent to the tele-media session but is advantagous (or simply more convenient) to include in the TMCP message instead of a proper tele-media stream. Examples of “raw data” include an image of the user's face or chat session text that is to be exchanged during the course of the chat session. The system's flexibility enables the system designer to specify the needed or desired elements, where these elements describe the contents of the message itself. By way of example only, the system designer could construct a complete TMCP message that consists of: TMCP URI, parameters or terms of engagement, raw data. Other TMCP message formats may be used as well.

It will be apparent to those skilled in the art that various modifications and variations can be made in the media control system and protocol of the present invention without departing from the scope or spirit of the invention. For example, TMCP relay 10 is described as being a type of software process but this module may be either incorporated into a hardware element such as an integrated circuit, distributed across several different processes to effect the functionality of TMCP relay 10 or any combination of hardware and software. Thus, it is intended that the present invention, the modifications and variations of this invention provided they come within the scope of the appended claims and their legally permissible equivalents.

What is claimed is:

1. A media stream control system for identifying and managing media data streams on a communications network, comprising
a relay module for identifying compatible media and issuing commands for the control of media data streams from the compatible media; and
a name server for resolving media identified by said user interface into address information compatible with the communications network.

2. A media stream control system, according to claim 1, wherein a browser plug-in system operatively coupled to said relay module translates identifier information and user commands from a user command format to a relay module message.

3. A media stream control system, according to claim 2, wherein said user command format is a graphical user interface.

4. A media stream control system, according to claim 1, including media stream applications for producing media data streams in response to said relay module.

5. A media stream control system according to claim 4, wherein said media streams include audio media data streams.

6. A media stream control system according to claim 4, wherein said media streams include video media data streams.

7. A media stream control system, according to claim 1, wherein said relay module is capable of communicating with other relay modules over communication network interconnections utilizing the Internet Protocol.

8. A media stream control system for identifying and controlling media data streams, comprising:
a control system;
a command interface for accepting identification of media stream device and operational command information;
wherein said control system issues commands for control of media stream generating devices and playback of media streams in response to identification of the media stream and said operational command information.

9. A media stream control system according to claim 8 wherein said command interface includes a browser display and browser plug-in for graphically displaying the commands and control information and communicating with the control system.

10. A method for identifying media streams in a communications network in which each of the participating computer systems in the network include modules for issuing commands corresponding to specific media streams identified, comprising:
designating the command as a media stream control command;
assigning a session identifier;
assigning an identifier of a media stream within the session; and
identifying the operation to be performed to control the media stream.

11. A method of identifying media streams, according to claim 10, wherein a session identifier is assigned for each source of streaming media data and an identifier is assigned for each media data stream from each corresponding source assigned a session identifier.

12. A method of identifying media streams, according to claim 10, wherein an identified operation includes initializing a media data stream.

13. A method for controlling a media stream generated on interconnected computers by a media stream application which controls the playback or generation of media stream data in response to operational commands which define desired behaviors of the media stream, comprising:
transmitting a predetermined identifier and an operational command from the end user to a media stream control module, said identifier identifying the media stream;
relaying the message to the media stream control module necessary for the generation and playback of the media stream;
translating, by the media stream control module that are relayed the message, media stream operational commands into instructions for the media stream application; and
performing the media stream operations specified.

14. The method according to claim 13, wherein said transmitting a predetermined identifier includes selecting a link within a browser and communicating the predetermined identifier through a browser plug-in module to the media stream control module.

15. The method according to claim 13, wherein said transmitting a predetermined identifier includes entering said predetermined identifier into a browser and communicating the predetermined identifier through a browser plug-in module to the media stream control module.

16. The method according to claim 13 including monitoring the media stream through a browser display and issuing commands to control the media stream through the browser display.
